(19) United States
(12) Patent Application Publication
(10) Pub. No.: US 2019/0389526 A1
(43) Pub. Date: Dec. 26, 2019

(54) Adjustable Windshield for a Motorcycle

(71) Applicant: Bayerische Motoren Werke Aktiengesellschaft, Muenchen (DE)

(72) Inventor: Patrick LEUCHTE, Muenchen (DE)

(21) Appl. No.: 16/564,695

(22) Filed: Sep. 9, 2019

Related U.S. Application Data
(63) Continuation of application No. PCT/EP2018/055715, filed on Mar. 8, 2018.

(30) Foreign Application Priority Data
May 19, 2017 (DE) 10 2017 208 478.2

(51) Int. Cl. B62J 17/04

(52) U.S. Cl. CPC B62J 17/04

(57) ABSTRACT

A motorcycle has an adjustable windshield assembly including a windshield and a first adjustment device. The first adjustment device is designed for selectively moving the windshield between a base position and a protection position. The windshield is arranged in the protection position in order to protect at least one headlamp of the motorcycle.

### CROSS REFERENCE TO RELATED APPLICATIONS

This application is a continuation of PCT International Application No. PCT/EP2018/055715, filed Mar. 8, 2018, which claims priority under 35 U.S.C. § 119 from German Patent Application No. 10 2017 208 478.2, filed May 19, 2017, the entire disclosures of which are herein expressly incorporated by reference.

### BACKGROUND AND SUMMARY OF THE INVENTION

The invention relates to a motorcycle with an adjustable windshield assembly.

In particular when travelling on gravel roads, on easy terrain or in off-road operation, there is an increased risk of stone impacts for motorcycles or vehicles similar to motorcycles, which, for example, are caused by vehicles travelling in front and lead to damage to the headlamp and to correspondingly high repair costs. In order to avoid this, until now a separate headlamp protector for the headlamp or headlamps was carried along and, if necessary, had to be mounted separately by the user. Since these protective devices generally do not have road approval, complicated mounting and demounting are thus necessary not only at the start of each country journey but in addition also at the end thereof, in order to be able to use the motorcycle again thereafter in road traffic.

It is therefore an object of the invention to provide a stone impact protector for a headlamp of a motorcycle which eliminates or at least reduces the aforementioned disadvantages. In particular the stone impact protector is to be easily available and easily usable as necessary.

This and other objects are achieved by a motorcycle with an adjustable windshield assembly. The windshield assembly comprises a windshield and a first adjustment device. The first adjustment device is designed for selectively moving the windshield between a base position and a protective position, wherein in the protective position the windshield is arranged to protect at least one headlamp of the motorcycle.

The windshield of the motorcycle is therefore not just used to protect the driver against wind and weather. Instead, the windshield can be moved as necessary from the base position provided for this purpose into the additionally available protective position. This is carried out by actuating the first adjustment device which, for example, can be operated mechanically and/or electrically and can be activated by the driver as needed.

For example, in the protective position the windshield at least partly, preferably completely, covers a front side of the headlamp pointing in the direction of travel. The windshield is therefore moved in front of the headlamp in such a way that the latter is at least partly or completely covered on its front side pointing in the direction of travel by the windshield arranged in front of the headlamp. Thus, in particular the front side of the headlamp, provided for the output of light, can be protected by the windshield against damage as a result of stone impact and other foreign bodies.

Preferably, at least one protective section of the windshield, covering the headlamp in the protective position, or the entire windshield, is transparent. In this way, the function of the headlamp is maintained even when the windshield is located in the protective position. The light emitted by the headlamp passes through the windshield on account of the partial or complete transparency of the same. The protective section of the windshield or the entire windshield can comprise transparent material for this purpose, in particular transparent plastic or particularly impact-resistant glass.

According to an embodiment, the headlamp is a front headlamp of the motorcycle. Since the latter is generally arranged underneath the windshield, the height of the windshield is lowered from the base position into the protective position located further down. However, this means that in this case the protection of the driver against wind and weather is reduced, since the windshield is moved further away from the driver and/or with respect to the base position. However, this is not inconsistent with a significant benefit for the driver. Protection for the headlamp against stone impact is all the more important the more stony the route is. In particular off the road, or in the country, the headlamp protection is particularly important; at the same time in this case a speed of travel is reduced anyway on account of the more difficult nature of the road. The protective action of the windshield for the driver against the influence of wind and weather therefore becomes secondary in this case. Instead, during a journey at high ambient temperatures, an increased application of wind to the driver can even be desirable, so that the lowering of the windshield is doubly advantageous to the driver.

Likewise, as a result of the lowering into the protective position, an upper edge of the windshield, facing the driver, is moved further away from the driver, so that a radius of action of the driver is increased. This offers the possibility that, with a large range of movement of the driver, in particular during country or off-road journeys, a collision with the upper edge can be avoided. The potential risk of injury is reduced further in this way.

According to a further embodiment, the first adjustment device is designed for the translational and/or rotational movement of the windshield between the base position and the protective position. This means that the movement of the windshield from the base position to the protective position can be carried out either translationally, that is to say within the scope of a linear movement, or as a rotational movement (rotary movement). Likewise, a combined movement, that is to say a combined translational and rotational movement, is possible in order to bring the windshield into the protective position. The same is true in the opposite direction of movement for a restorative movement, in order to move the windshield out of the protective position and back to the base position. For example, the first adjustment device is connected directly to the windshield for this purpose.

For example, the first adjustment device can comprise at least two guide rails, in particular telescopic rails, arranged parallel to one another, for the translational movement of the windshield between the base position and the protective position. This arrangement permits particularly simple and easily operable adjustment of the windshield.

According to a further embodiment, the windshield can additionally be movable, in particular translationally and/or rotationally, between the base position and at least one elevated position by means of the first adjustment device.

Therefore, in addition to the adjustability between the protective position and the base position, the windshield can additionally be matched to the requirements of the driver for suitable wind and weather protection, should this be the primary need instead of the stone impact protection.

In this case, the windshield can be moved out of the protective position back into the base position (if this has not yet been done). The windshield is then moved with the aid of the first adjustment device out of the base position into one or into one of the more elevated positions. If the first adjustment device—as described—is designed for the translational and/or rotational movement of the windshield, then it is not only possible for the movement between the base position and the protective position to be carried out in this way but for the first adjustment device additionally to be configured in such a way that the movement between the base position and the at least one elevated position can be carried out in this way, that is to say by means of translational and/or rotational movement of the windshield.

In addition, for this purpose the windshield assembly can comprise a separate, second adjustment device for the independent adjustment of an inclination and/or a height of the windshield. This means that the first adjustment device can be moved at least for the described movement of the windshield between the base position and the protective position for the headlamp. On the other hand, the setting of the inclination and/or the height of the windshield is carried out by means of the second adjustment device, which can be actuated independently of the first adjustment device.

For example, for this purpose the second adjustment device is firstly movably connected to the motorcycle and secondly directly or indirectly to the windshield. An indirect connection to the windshield is provided, for example, by a second adjustment device which at one end is connected to the motorcycle and at the other end is connected to the first adjustment device or to a windshield carrier carrying the first adjustment device. In this case, the windshield is arranged on the first adjustment device, wherein the adjustment device can optionally be mounted on the windshield carrier. In any case, an inclination and/or height of the first adjustment device can thus be set by means of the second adjustment device and, in this way, an inclination and/or a height of the windshield can likewise be set. In addition, here the second adjustment device is adjustable independently of the first adjustment device.

The windshield assembly described thus permits particular protection of the headlamp in all embodiments, which protection can be used easily, so that no separate headlamp protection has to be carried along and mounted as necessary. Instead, the windshield that is present in any case can be pushed in front of the headlamp as a stone impact protector to protect the headlamp. This windshield assembly can easily be combined with existing windshield assemblies, so that upgrading existing vehicles is also easily possible.

Within the context of this description, a motorcycle is likewise intended to be understood as vehicles similar to motorcycles. Vehicles similar to motorcycles are to be understood as, for example, single-track vehicles or two-track vehicles, in particular those with a saddle-like driver's seat, and vehicles which permit an inclination, such as scooters, two-wheeled, three-wheeled or four-wheeled motor scooters.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a partially illustrated front view of a motorcycle according to the description.

FIG. 2 is a partial side view of the motorcycle from FIG. 1 in a protective position.

FIG. 3 is a partial side view of the motorcycle from FIG. 1 in a base position.

### DETAILED DESCRIPTION OF THE DRAWINGS

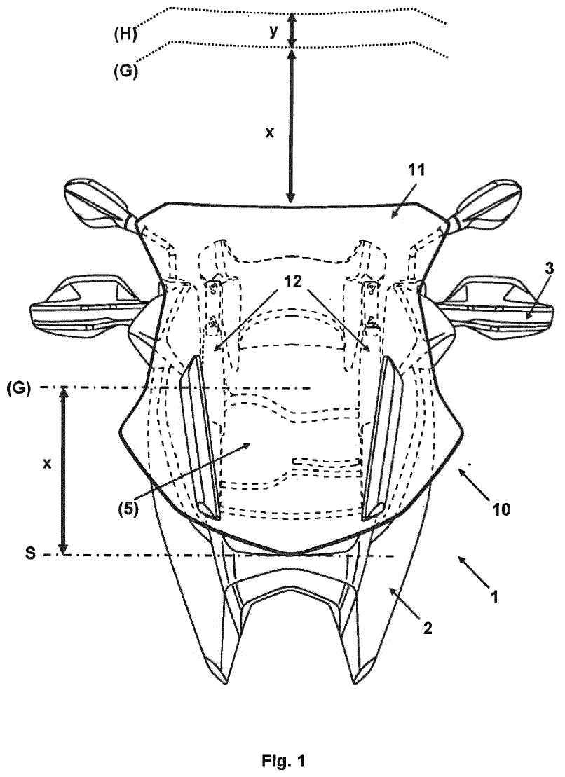

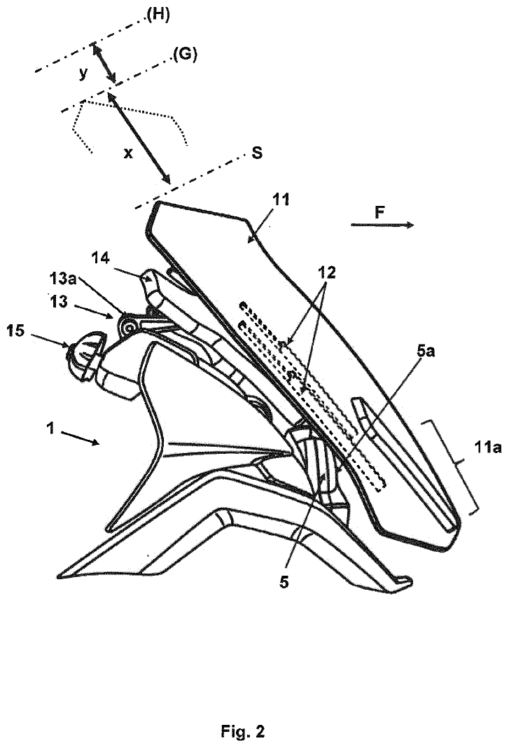

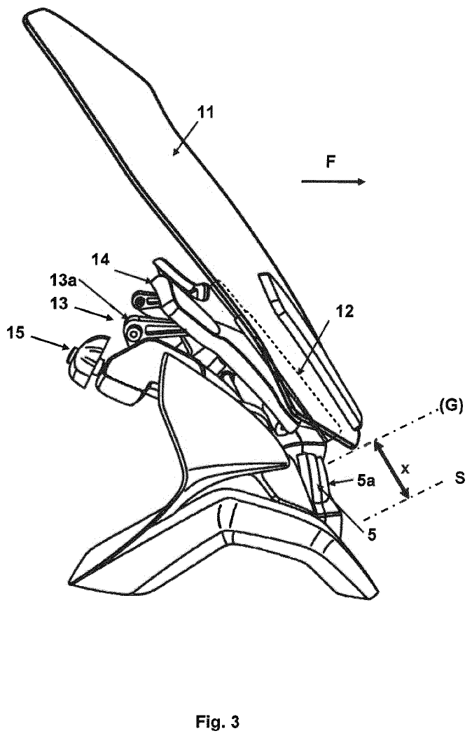

FIG. 1 shows a front view of a motorcycle 1, merely illustrated partly. The motorcycle 1 has a front mudguard 2 for a front wheel, not illustrated, handlebars 3 and an adjustable windshield assembly 10, and also a front headlamp 5 (merely indicated in phantom in FIG. 1) hidden by the windshield assembly 10. The windshield assembly 10 comprises a windshield 11 and a first adjustment device 12. The first adjustment device 12 is designed for the optional movement (arrow x) of the windshield 11 between a base position G (merely indicated schematically in FIGS. 1 and 2 for a lower edge and an upper edge of the windshield 11, illustrated explicitly in FIG. 3) and a protective position S (illustrated in FIGS. 1 and 2) for the front headlamp 5 of the motorcycle 1. In the protective position S for protecting the headlamp 5 of the motorcycle 1 (referred to a direction of travel F), the windshield 11 is arranged in front of said headlamp. The front headlamp 5 can comprise one or more headlamps, for example a low beam and an additional high beam.

In the protective position S illustrated, the windshield 11 is arranged in front of the headlamp 5 in the direction of travel F (in the same direction as a vehicle longitudinal axis of the motorcycle 1), and thus at least partly or preferably completely covers the front side 5a of the headlamp 5 pointing in the direction of travel F. In order nevertheless to secure usability of the headlamp 5 as lighting, the entire windshield 11 can be transparent. Alternatively, only a protective section 11a of the windshield 11 covering the headlamp 5 can be transparent. In this case, the protective section is defined by a section of the windshield 11 that is arranged in front of the headlamp 5 in the direction of travel F.

The first adjustment device 12 is designed at least for the translational movement of the windshield 11 between the base position G and the protective position S. To this end, the first adjustment device 12 comprises two guide rails arranged parallel to each other which, for example, are formed as telescopic rails, in order to permit the translational movement (arrow x) of the windshield 11 between the base position G and the protective position S.

In addition, by means of the first adjustment device 12, the windshield 11 can additionally be movable between the base position G and at least one elevated position H (merely indicated schematically in FIGS. 1 and 2), in particular translationally and/or rotationally (arrow y).

The windshield assembly 10 additionally comprises a separate, second adjustment device 13, which is designed for the independent adjustment of an inclination and of a height of the windshield 11. According to the embodiment illustrated, the second adjustment device 13 is firstly movably connected to the motorcycle 1 and secondly indirectly connected to the windshield 11 for this purpose. The indirect connection to the windshield 11 is, for example, provided by the second adjustment device 13 firstly being connected to the motorcycle 1 and secondly to a windshield carrier 14 carrying the first adjustment device 12. The windshield 11 in this case is arranged on the first adjustment device 12, wherein the adjustment device 12 is optionally mounted on the windshield carrier 14, wherein the windshield carrier 14 is in turn adjustable with respect to the remainder of the motorcycle 1 via the second adjustment device 13. The second adjustment device 13 has a multi-link mechanism 13a, merely by way of example in the embodiment illustrated, having levers that can be rotated or pivoted relative to one another, in particular a four-link mechanism. The multi-link mechanism 13a can be operable electrically or by the user—such as by way of an illustrated hand wheel 15.

In any case, by way of the second adjustment device 13, an inclination and height of the first adjustment device 12 and, in this way, likewise an inclination and height of the windshield 11, can thus be set. Here too, the second adjustment device 13 is adjustable independently of the first adjustment device 11.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A motorcycle with an adjustable windshield assembly, comprising:
a windshield; and
a first adjustment device, wherein
the first adjustment device is configured for selectively moving the windshield between a base position and a protective position, and
in the protective position, the windshield is arranged to protect at least one headlamp of the motorcycle.

2. The motorcycle according to claim 1, wherein
in the protective position, the windshield at least partly covers a front side of the headlamp pointing in a direction of travel.

3. The motorcycle according to claim 2, wherein
in the protective position, the windshield completely covers the front side of the headlamp.

4. The motorcycle according to claim 1, wherein
at least one protective section of the windshield, covering the headlamp in the protective position, is transparent.

5. The motorcycle according to claim 4, wherein
the windshield is entirely transparent.

6. The motorcycle according to claim 1, wherein
the headlamp is a front headlamp of the motorcycle.

7. The motorcycle according to claim 1, wherein
the first adjustment device is configured for translational and/or rotational movement of the windshield between the base position and the protective position.

8. The motorcycle according to claim 7, wherein
the first adjustment device comprises at least two guide rails arranged parallel to one another for the translational movement of the windshield between the base position and the protective position.

9. The motorcycle according to claim 8, wherein
the at least two guide rails are telescopic rails.

10. The motorcycle according to claim 1, wherein
the windshield is additionally movable between the base position and at least one elevated position via the first adjustment device.

11. The motorcycle according to claim 10, wherein
the additional movement is one or both of a translational and rotational movement.

12. The motorcycle according to claim 1, further comprising:
a separate, second adjustment device for independent adjustment of an inclination and/or a height of the windshield.
